(19) United States
(12) Patent Application Publication
(10) Pub. No.: US 2016/0263941 A1
(43) Pub. Date: Sep. 15, 2016

(54) Axle Housing

(71) Applicant: Caterpillar Inc., Peoria, IL (US)

(72) Inventor: Jeffrey Jensen, Dunlap, IL (US)

(73) Assignee: Caterpillar Inc., Peoria, IL (US)

(21) Appl. No.: 14/656,194

(22) Filed: Mar. 12, 2015

(51) Int. Cl. B60B 35/16; F16H 37/08

(52) U.S. Cl. CPC B60B 35/166; F16H 37/0813

(57) ABSTRACT

An axle housing for a powered machine is disclosed. The axle housing may include a support casing extending between a first and a second end. The support casing may further include a support member for at least partially bearing the weight of the powered machine and at least two apertures therethrough.

### TECHNICAL FIELD

This disclosure generally relates to housings for powered machines and, more specifically, relates to axle housings for powered machines.

### BACKGROUND

Generally speaking, a powered machine includes an operator station and a power train. Typically, the power train includes a power source, a power transmission device, a drive shaft, an axle assembly and one or more wheels, or other motive devices, that transfer power of the power source to the ground. Commonly, the power transmission device includes an input end and an output end, and the input end is operatively engaged with the power source, while its output end is rotatably engaged with a first side of the drive shaft. The drive shaft may also have a second side, and this second side is rotatably engaged with the axle assembly. The axle assembly may include a support casing and one or more axles, and the one or more axles may be rotatably engaged with the second end of the drive shaft. Furthermore, the one or more axles may be rotatably engaged with the one or more wheels, or other motive devices, that transfer power of the power source to the ground.

As power from the power source is created, it is passed to the input end of the power transmission device. As the power of the power source is transferred through the power transmission device from the input end to the output end, it is converted to a rotating driven load. This rotating driven load is then passed from the output end to the first end of the drive shaft. Subsequently, this rotating driven load is passed to the second end of the drive shaft and then passed to the at least one axle of the axle assembly. As the at least one or more axles of the axle assembly is rotatably engaged with the second end of the drive shaft, the rotating driven load is subsequently passed to the at least one or more axles. Since the one or more axles are rotatably engaged with the one or more wheels, or other motive devices that transfer power of the power source to the ground, these motive devices thereby rotated and thus propel the powered machine to which such power train is attached.

In order to decrease fuel consumption, and thereby increase operational efficiency, powered machine designers are continually seeking ways to decrease the weight of power train components, while also maintaining the structural strength necessary to operate such powered machine. The axle housing of an axle assembly is no exception.

One attempt to decrease weight of a component is disclosed in U.S. patent application Ser. No. 11/222,985 (the '985 patent application). The '985 patent application is directed to a flexible inspection and access view port for a heating, ventilation and air-conditioning (HVAC) system. The '985 patent application does so by providing a view port in the ducting of such HVAC systems, and then covering such port with a flexible material that conforms to the shape of the duct, such as around a rounded-corner.

While arguably effective for its specific purpose, the '985 patent application is related to view ports, namely view ports in the ducting of HVAC systems, and is in no way related to the axle housings of powered machines. Moreover, axle housings of powered machines are subjected to significantly greater stresses than the view ports in the ducting of an HVAC system. For example, the weight of the axle housing on powered machines is typically many times greater than the weight of a normal length of HVAC ducting. Adding in the weight of the powered machine that the axle housing must support, and any load and operator the machine also hauls, it is seen that the weight the axle housing must support is orders of magnitude greater than the weight a HVAC duct. Furthermore, unlike the HVAC systems, axle housings of powered machines are subject to rotating torque forces, while ducting of HVAC systems generally are not. Accordingly, the HVAC ducting system described in the '985 patent application would not withstand the forces to which the support casing of the axle assembly of a powered machine is exposed.

The present disclosure is directed to overcoming one or more problems set forth above and/or other problems associated with the prior art.

### SUMMARY

In accordance with one embodiment of the present disclosure, an axle housing for a powered machine is disclosed. The housing may include a support casing extending between a first end and a second end. The support casing may further include a support member for at least partially bearing the weight of the powered machine, and further include at least two apertures therethrough.

In accordance with another embodiment of the present disclosure, an axle assembly for a powered machine is disclosed. The axle assembly may include an axle housing and at least one axle. The axle housing may include a support casing extending between a first end and a second end, at least one support member for at least partially bearing the weight of the powered machine and at least two apertures therethrough. The support casing may circumscribe at least a portion of the at least one axle.

In accordance with another embodiment of the present disclosure, a power train for a powered machine is disclosed. The power train may include a power source, a power transmission device, a drive shaft, an axle assembly and at least one motive device for transferring power of the power source to the ground. The power transmission device may be operatively engaged with the power source. The drive shaft may include a first side and a second side. The first side of the drive shaft may be rotatably engaged with the power transmission device, while its second side may be operatively engaged with the axle assembly. The axle assembly may include an axle housing and at least one axle. The axle housing may include a support casing extending between a first end and a second end, the support casing may additionally include a support member for at least partially bearing the weight of the powered machine, and also include at least two apertures therethrough. Additionally, the support casing may circumscribe at least a portion of the at least one axle. Finally, the at least one motive device for transferring power of the power source to the ground may be rotatably associated with the at least one axle.

These and other aspects and features of the present disclosure will be more readily understood when read in conjunction with the accompanying drawings.

### BRIEF DESCRIPTION

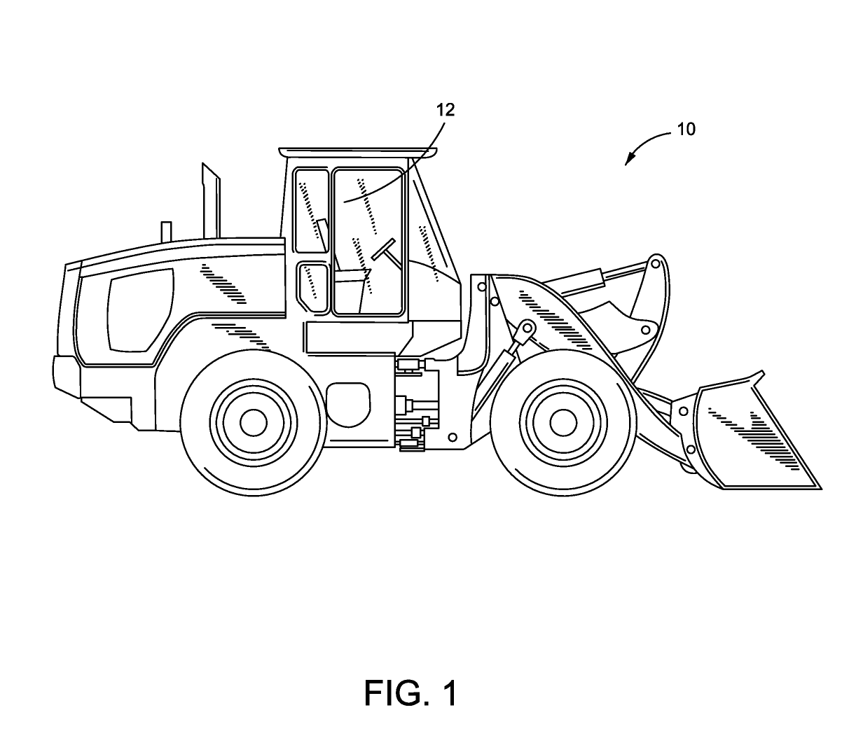

FIG. 1 is a side, plan view of a powered machine constructed in accordance with the present disclosure.

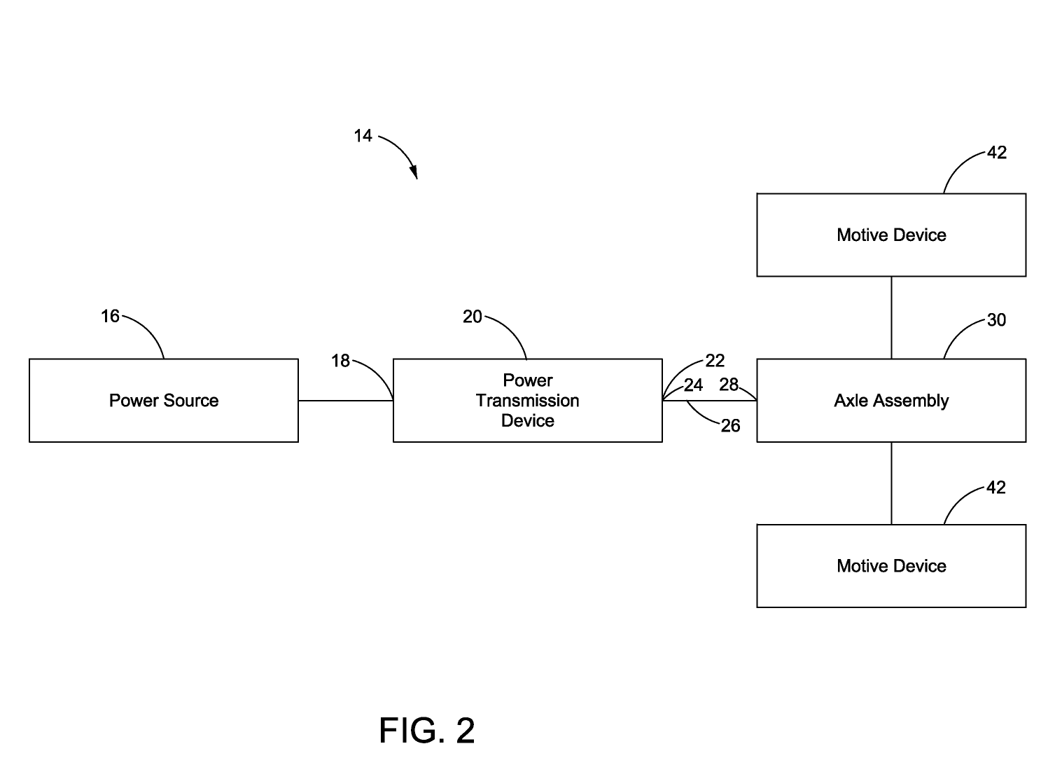

FIG. 2 is a schematic of a power train that may be used in conjunction with the powered machine of FIG. 1.

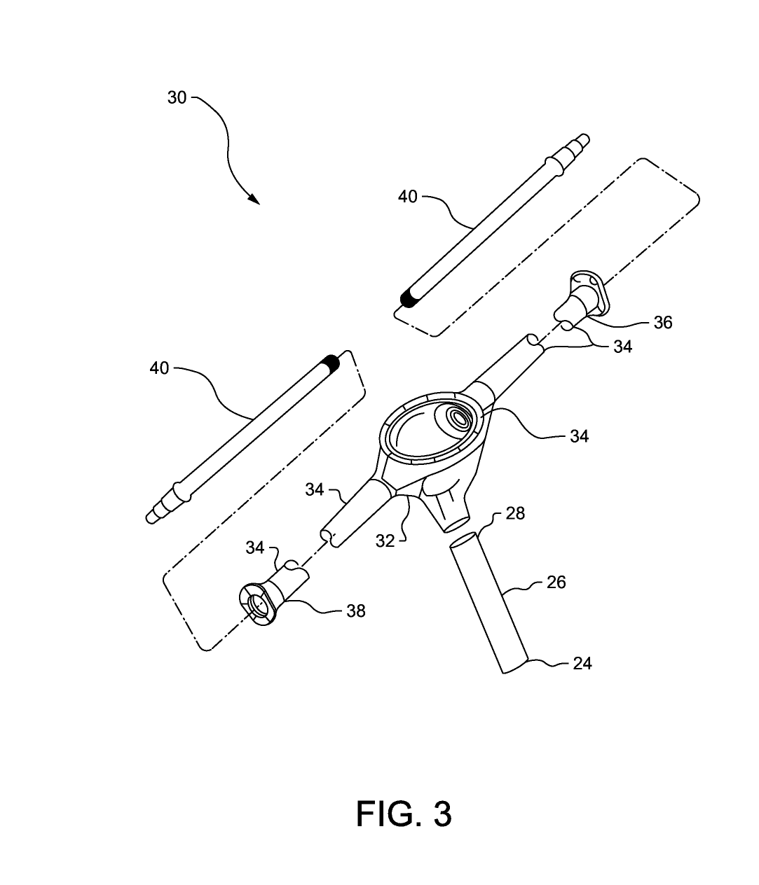

FIG. 3 is a fragmentary, exploded, perspective view of an axle assembly that may be used in conjunction with the power train of FIG. 2.

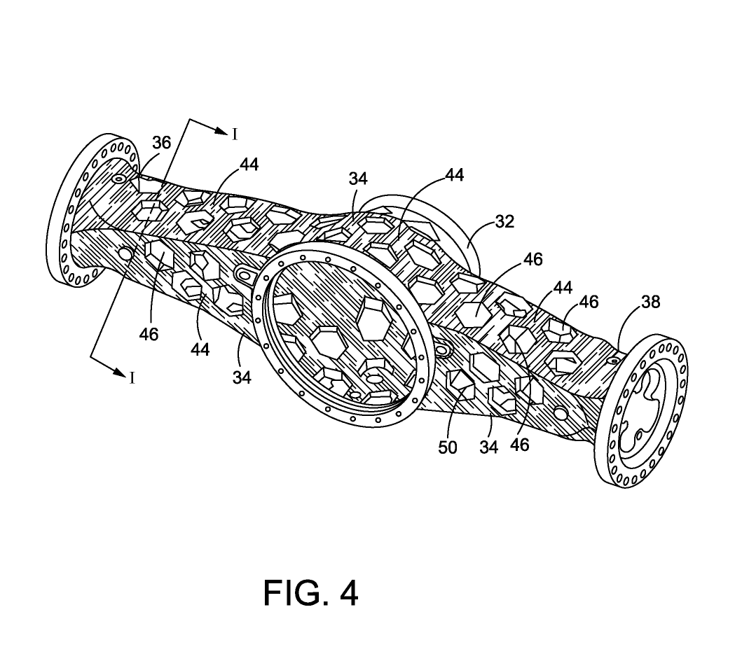

FIG. 4 is a perspective view an axle housing that may be used in conjunction with the axle assembly according to FIG. 3.

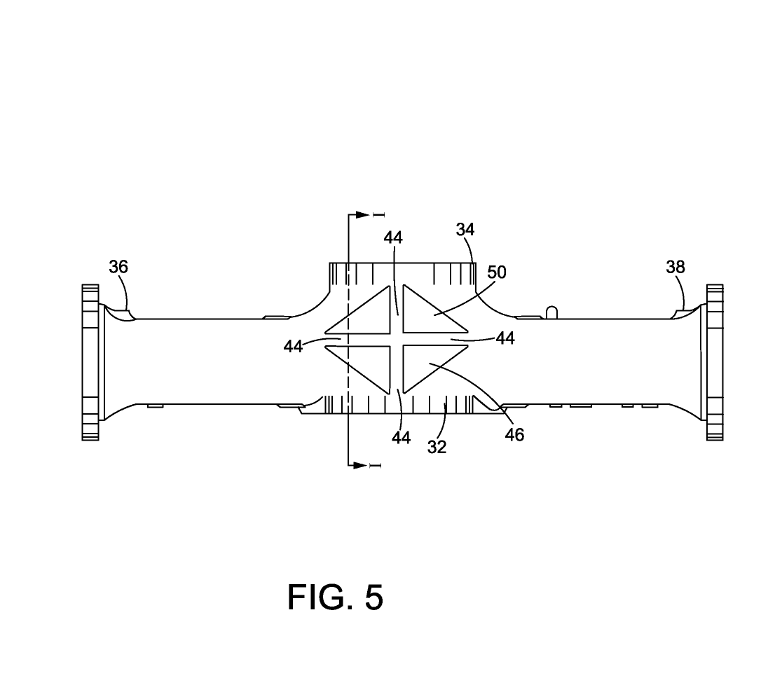

FIG. 5 is a top-down, plan view of an axle housing that may be used in conjunction with the axle assembly according to FIG. 3.

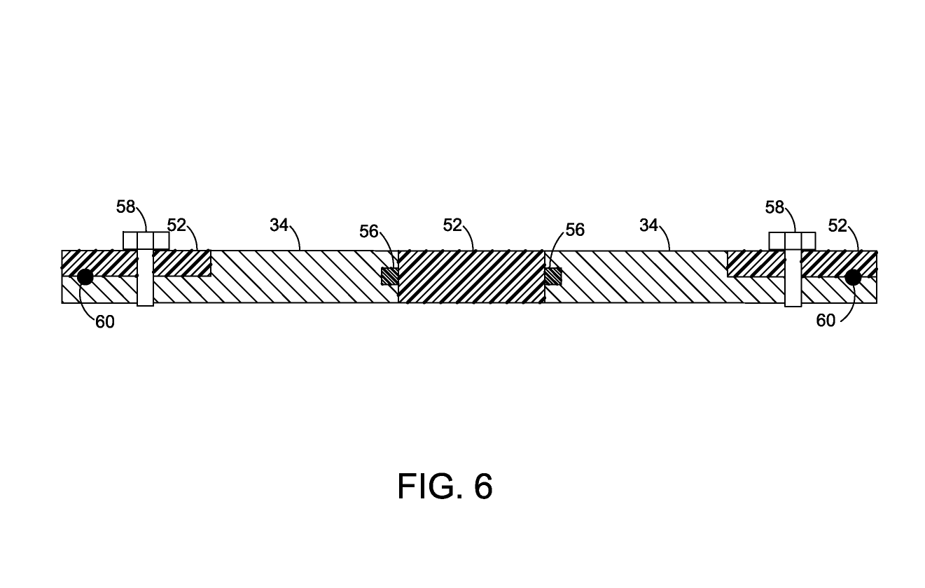

FIG. 6 is cross-sectional view along line I-I of FIGS. 4-5 demonstrating the window system, along with an optional fastening and seal system that may be used in conjunction with the axle housing according to FIGS. 4-5.

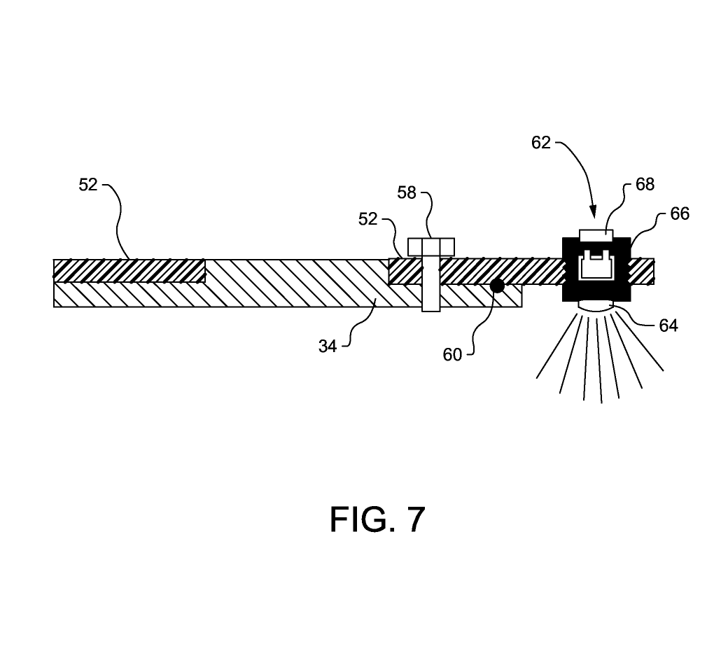

FIG. 7 is a cross-sectional view along line I-I of FIGS. 4-5 demonstrating the window system, along with an optional fastening and seal system, and further an optional interior inspection system that may be used in conjunction with the housing according to FIGS. 4-5.

### DETAILED DESCRIPTION OF THE DISCLOSURE

Referring now to the drawings, and with specific reference to FIG. 1, a powered machine is shown and generally referred to be reference numeral 10. While the powered machine 10 is generally depicted as a wheel loader, it is to be understood that this is only exemplary, as the teaching of the present disclosure can be employed elsewhere as well. For example, the present disclosure may be utilized with other powered machines 10, such as, automobiles, pickup trucks, on highway trucks, off highway trucks, articulated trucks, asphalt pavers, excavators, compactors, track-type tractors, motor graders, forest skidders, backhoe loaders, forklifts and the like. The powered machine 10 may further include an operator station 12.

Turning now to FIG. 2, a power train of the powered machine 10 is schematically depicted and generally referred to be reference numeral 14. The power train 14 may include a power source 16, such as an electric motor or an internal combustion engine. This power source 16 may be operatively engaged with an input end 18 of a power transmission device 20. While not meaning to be limiting, the power transmission device 20 may be, for example, a transmission, a torque convertor, a hydrostatic drive and combinations thereof. The power transmission device 20 may further include an output end 22. As power from the power source 16 is created, it is passed to the input end 18 of the power transmission device 20. As this power is transferred through the power transmission device 20 to the output end 22, the power is converted to a rotating driven load.

The output end 22 of the power transmission device 20 may be rotatably engaged with a first side 24 of a drive shaft 26. This drive shaft 26 may further include a second side 28, and this second side 28 may be rotatably engaged with an axle assembly 30. Turning now to FIG. 3, it can be seen that the axle assembly 30 may include an axle housing generally referred to by reference numeral 32. More specifically, the axle housing 32 may include a support casing 34 that extends between a first end 36 and a second end 38. Furthermore, the axle assembly may include at least one axle 40, and the support casing 34 may circumscribe at least some portion of the at least one axle 40. Turning back now to FIG. 2, the at least one axle 40 of the axle assembly 30 may be rotatably associated with at least one motive device 42 for transferring the power of the power source 16 to the ground. While not meant to be all encompassing, some examples of the at least one motive device 42 for transferring power of the power source 16 to the ground, include, wheels and tracks of track-type tractors or excavators.

Referring now to FIGS. 2-3, as power from the power source 16 is created, it is passed to the input end 18 of the power transmission device 20. As the power of the power source 16 is transferred through the power transmission device 20 from the input end 18 to the output end 22, it is converted to a rotating driven load. This rotating driven load is then passed from the output end 22 to the first side 24 of the drive shaft 26. Subsequently, this rotating driven load is passed to the second side 28 of the drive shaft 26 and then passed to the at least one axle 40 of the axle assembly 30. As the at least one axle 40 of the axle assembly 30 is rotatably engaged with the second side 28 of the drive shaft 26, the rotating driven load is subsequently passed to the at least one axle 40. Since the at least one axle 40 is rotatably engaged with one or more motive devices 42 for transferring power of the power source 16 to the ground, such motive devices 42 are thereby rotated and thus propel the powered machine 10 to which such power train 14 is attached.

In order to decrease fuel consumption, and thereby increase operational efficiency, powered machine 10 designers are continually seeking ways to decrease the weight of power train 14 components, while also maintaining the structural strength needed to operate such powered machines 10. The axle housing 32 of the axle assembly 30 is no exception. Turning now to FIGS. 4-5, the support casing 34 of the axle housing 32 may further include a support member 44 for at least partially bearing the weight of the powered machine 10, and further include at least two apertures 46 therethrough. Furthermore, and now while specifically referring to FIG. 4, the support member 44 may be located between the at least two apertures 46. Additionally, such support casing 34 may include at least two support members 44 for at least partially bearing the weight of the powered machine 10, and at least three apertures 46 therethrough. Moreover, each support member 44 may be located between at least two of the at least three apertures 46. Referring now to FIG. 5, the support casing 34 may include at least three support members 44, and at least four apertures 46 therethrough. Further, in such instance, each support member 44 may be located between at least two of the at least four apertures 46.

The support casing 34 may be made of a first material 48, and this first material 48 may be a metal or metal alloy selected from the group consisting of iron, ductile iron, steel, stainless steel, aluminum, aluminum alloy, titanium, titanium alloy, nickel, nickel alloy and combinations thereof. Furthermore, each aperture 46 may define a space 50 in which an inspection window 52 may be located.

This inspection window 52 may be made of a second material 54. This second material 54 may be less dense than the first material 48. Further, such second material 54 may be translucent. Additionally, the second material 54 may be a polymeric material selected from the group consisting of polyester, thermoset urethane, cyanate ester, vinyl ester, polyimide, bisphenol A epoxy, bisphenol F epoxy, novolac epoxy, glycidyl epoxy, cycloaliphatic epoxy, glycidylamine epoxy, melamine, phenol formaldehyde, polyhexahydrotriazine, low density polyethylene, medium density polyethylene, high density polyethylene, ultra-high molecular weight polyethylene, polyvinyl chloride, polyethylene terephthalate, vinyl, polypropylene, poly(methyl methacrylate), nylon, polybenzimidazole, polystyrene, polytetrafluroethylene, polyetherimide, polyether ketone, polyether ether ketone, acrylonitrile butadiene styrene, styrene acrylonitrile, acrylonitrile styrene acrylate, polyamide, polyaryl ether ketone, polycarbonate, polyoxymethylene, polyphenylene ether, polyphenylene sulfide, polysulfone, polybutylene terephthalate, thermoset urethane, cellulose acetate butyrate, glycol modified polyethylene terphthalate, polycarbonate and combinations thereof.

Turning now to FIG. 6, a cross-section of the support casing 34 and inspection window 52 is depicted. As seen there, the inspection window may have one or more lips 56 and be molded into the support casing 34. Alternatively, as is also seen in this drawing, the inspection window 52 may be fastened to the support casing 34 by a fastener 58. In this instance, a seal 60, such as a pliable O-ring, may also be located between the inspection window 52 and the support casing 34.

Referring now to FIG. 7, a second cross-section of the support casing 34 and inspection window 52 is shown. As depicted in this figure, an inspection system, generally referred to by reference numeral 62, may also be disposed in at least one inspection window 52. Further, this inspection system 62 may include a light 64, a body 66 that supports the light 64, and a switch 68 that controls power to the light 64. In one instance, the light 64 may be an incandescent light (e.g., Edison-type). In another instance, the light 64 may be a light emitting diode (LED) light. In further instances, the light 64 may be a UV light or even a fluorescent light.

In further instances, the axle housing 32 may be filled with a lubricating fluid, 70, such as, gear oil (not shown). In such instance, each space 50 may include an inspection window 52 molded into, or fastened to, the support casing, thereby retaining the lubricating fluid 70. Thus, when the light 66 of the inspection system 62 is powered on, the amount lubricating fluid 70 inside the axle housing 32 may be determined by visual inspection. Alternatively, the lubricating fluid 70 may further include a dye, 72, such as, an Ultraviolet-Visible (UV-Vis) dye, a fluorescent dye, an Ultraviolet (UV) dye and combinations thereof (not shown). When the lubricating fluid 70 comprises a dye 72, a wavelength of light emitted by the light 64 may excite the dye 72, thereby making it simpler to assess the amount of lubricating fluid 70 inside the axle housing 32. In this instance, the type of light 64 (i.e., incandescent, UV, fluorescent, etc.) may be chosen to coincide with the dye 72 to be utilized in the lubricating fluid 70.

Subsequently, if the amount of lubricating fluid 70 in the axle housing 32 is determined to be low, one or more inspection windows 52, such as an inspection window 52 fastened to the support casing 34 with a fastener 58, may be removed. Then, lubricating fluid 70 may be added to the axle housing 32. Additionally, one or more inspection windows 52 may be removed from the support casing 34 in order to access or inspect power train 14 components located inside the axle housing 32. For example, an inspection window 52 may be removed to access or inspect a differential system, a bevel gear set, planetary gear sets, axle sets, braking systems, or other components, disposed inside the axle housing.

### INDUSTRIAL APPLICABILITY

In operation, an axle housing having a support casing, and wherein the support casing further includes a support member for at least partially bearing the weight of a powered machine, and the support casing further including at least two apertures therethrough, finds use in an axle assembly. More specifically, this axle assembly finds use in the power train of powered machines, such as, automobiles, pickup trucks, on highway trucks, off highway trucks, articulated trucks, asphalt pavers, excavators, compactors, track-type tractors, motor graders, forest skidders, backhoe loaders, forklifts, wheel loaders, and the like.

Generally, powered machines include a power train, and this power train typically includes a power source, a power transmission device, a drive shaft, an axle assembly, and one or more wheels that transfer the power of the power source to the ground. As power from the power source is created, it is passed to the power transmission device where it is converted to a rotating drive load. This rotating driven load is then passed to the drive shaft and then to the axle assembly, where the load is passed to the axle and subsequently to the one or more wheels, thereby rotating the wheels and propelling the powered machine.

In order to decrease fuel consumption, and thereby increase operational efficiency, powered machine designers are continually seeking ways to decrease the weight of power train components, while also maintaining the structural strength necessary to operate such powered machine. An axle housing of the axle assembly is one such component. Accordingly, the current application discloses novel and non-obvious axle housings having a support casing that extends between a first end and a second end. The support casing may further include a support member for at least partially bearing the weight of the powered machine, and further including at least two apertures therethrough. Further, such support casing may include any number of support members, and any number of apertures therethrough. Each support member may be located between at least two of the any number of apertures. Further, inspection windows may be molded into, or fastened to, the support casing. These inspection windows may be made of a different material than the support casing, and this different material generally is less dense than the material used to make the support casing, thereby decreasing the weight of the axle housing. In some instances, each aperture may have an inspection window molded into, or fastened to, the support casing. Furthermore, this different material may be translucent, and thereby allow visual inspection of other power train components disposed inside the axle housing, such as, a differential system, a bevel gear set, planetary gear sets, axle sets, and in some instances, braking systems. In the instance the axle housing is filled with a lubricating fluid, such as, gear oil, each aperture may include an inspection window molded into, or fastened to, the support casing. Additionally, the gear oil may further include a dye, thereby making the visual determination of the amount of lubricating fluid inside the axle housing easier to undertake.

The above description is meant to be representative only, and thus modifications may be made to the embodiments described herein without departing from the scope of the disclosure. Thus, these modifications fall within the scope of present disclosure and are intended to fall within the appended claims.

What is claimed is:

1. An axle housing for a powered machine, comprising:
a support casing extending between a first end and a second end, the support casing including a support member for at least partially bearing the weight of the powered machine, the support casing including at least two apertures therethrough.

2. The axle housing for a powered machine according to claim 1, wherein the support member is located between the at least two apertures.

3. The axle housing for a powered machine according to claim 1, the support casing including at least two support members for at least partially bearing the weight of the powered machine, the support casing including at least three apertures therethrough, and wherein each support member of the at least two support members is located between at least two of the at least three apertures.

4. The axle housing for a powered machine according to claim 1, the support casing including at least three support members for at least partially bearing the weight of the powered machine, the support casing including at least four apertures therethrough, and wherein each support member of the at least three support members is located between at least two of the at least four apertures.

5. The axle housing for a powered machine according to claim 1, wherein the support casing is made of a first material and each aperture defines a space, and further including an inspection window disposed in at least one of the spaces, the inspection window comprising a second material.

6. The axle housing for a powered machine according to claim 5, wherein the first material is a metal or metal alloy selected from the group consisting of iron, ductile iron, steel, stainless steel, aluminum, aluminum alloy, titanium, titanium alloy, nickel, nickel alloy and combinations thereof.

7. The axle housing for a powered machine according to claim 5, wherein the second material is less dense than the first material.

8. The axle housing for a powered machine according to claim 5, wherein the second material is translucent.

9. The axle housing for a powered machine according to claim 5, wherein the second material is polymeric material selected from the group consisting of polyester, thermoset urethane, cyanate ester, vinyl ester, polyimide, bisphenol A epoxy, bisphenol F epoxy, novolac epoxy, glycidyl epoxy, cycloaliphatic epoxy, glycidylamine epoxy, melamine, phenol formaldehyde, polyhexahydrotriazine, low density polyethylene, medium density polyethylene, high density polyethylene, ultra-high molecular weight polyethylene, polyvinyl chloride, polyethylene terephthalate, vinyl, polypropylene, poly(methyl methacrylate), nylon, polybenzimidazole, polystyrene, polytetrafluroethylene, polyetherimide, polyether ketone, polyether ether ketone, acrylonitrile butadiene styrene, styrene acrylonitrile, acrylonitrile styrene acrylate, polyamide, polyaryl ether ketone, polycarbonate, polyoxymethylene, polyphenylene ether, polyphenylene sulfide, polysulfone, polybutylene terephthalate, thermoset urethane, cellulose acetate butyrate, glycol modified polyethylene terphthalate, polycarbonate and combinations thereof.

10. The axle housing for a powered machine according to claim 5, wherein the inspection window is molded into the support casing.

11. The axle housing for a powered machine according to claim 5, wherein the inspection window is fastened to the support casing, and further includes a seal located between the support casing and the inspection window.

12. The axle housing for a powered machine according to claim 8, further including an inspection system disposed in the inspection window, the inspection system including a light, a body supporting the light and a switch for controlling power to the light.

13. An axle assembly for a powered machine, comprising:
an axle housing, the axle housing including a support casing extending between a first end and a second end, the support casing including a support member for at least partially bearing the weight of the powered machine, the support casing including at least two apertures therethrough; and
at least one axle, the support casing circumscribing at least a portion of the at least one axle.

14. The axle assembly for a powered machine according to claim 13, wherein the support member is located between the at least two apertures.

15. The axle assembly for a powered machine according to claim 13, the support casing including at least two support members at least partially bearing the weight of the powered machine, the support casing including at least three apertures therethrough, and wherein each support member of the at least two support members is located between at least two of the at least three apertures.

16. The axle assembly for a powered machine according to claim 13, the support casing including at least three support members at least partially bearing the weight of the powered machine, the support casing including at least four apertures therethrough, and wherein each support member of the at least three support members is located between at least two of the at least four apertures.

17. The axle assembly for a powered machine according to claim 13, wherein the support casing is made of a metal or metal alloy selected from the group consisting of iron, ductile iron, steel, stainless steel, aluminum, aluminum alloy, titanium, titanium alloy, nickel, nickel alloy and combinations thereof, and wherein each aperture of the support casing defining a space and further including a window disposed in at least one the at least two apertures, and the window is made of a polymeric material selected from the group consisting of polyester, thermoset urethane, cyanate ester, vinyl ester, polyimide, bisphenol A epoxy, bisphenol F epoxy, novolac epoxy, glycidyl epoxy, cycloaliphatic epoxy, glycidylamine epoxy, melamine, phenol formaldehyde, polyhexahydrotriazine, low density polyethylene, medium density polyethylene, high density polyethylene, ultra-high molecular weight polyethylene, polyvinyl chloride, polyethylene terephthalate, vinyl, polypropylene, poly(methyl methacrylate), nylon, polybenzimidazole, polystyrene, polytetrafluroethylene, polyetherimide, polyether ketone, polyether ether ketone, acrylonitrile butadiene styrene, styrene acrylonitrile, acrylonitrile styrene acrylate, polyamide, polyaryl ether ketone, polycarbonate, polyoxymethylene, polyphenylene ether, polyphenylene sulfide, polysulfone, polybutylene terephthalate, thermoset urethane, cellulose acetate butyrate, glycol modified polyethylene terphthalate, polycarbonate and combinations thereof.

18. A power train for a powered machine, comprising:
a power source;
a power transmission device, the power transmission device operatively engaged with the power source;
a drive shaft, the drive shaft having a first side and a second side, the first side rotatably engaged with the power transmission device;
an axle assembly, the second side of the drive shaft rotatably engaged with the axle assembly, the axle assembly comprising:
an axle housing, the axle housing including a support casing extending between a first end and a second end, the support casing including a support member for at least partially bearing the weight of the powered machine, the support casing including at least two apertures therethrough
at least one axle, the support casing circumscribing at least a portion of the at least one axle; and
at least one motive device for transferring power of the power source to the ground, the at least one motive device for transferring the power of the power source to the ground rotatably associated with the at least one axle.

19. The power train for a powered machine according to claim 18, wherein the support members is located between the at least two apertures.

20. The power train for a powered machine according to claim 18, the support casing including at least two support members at least partially bearing the weight of the powered machine, the support casing including at least three apertures therethrough, and wherein each support member of the at least two support members is located between at least two of the at least three apertures.
